(19) United States
(12) Patent Application Publication
(10) Pub. No.: US 2010/0222905 A1
(43) Pub. Date: Sep. 2, 2010

(54) ELECTRONIC APPARATUS WITH AN INTERACTIVE AUDIO FILE RECORDING FUNCTION AND METHOD THEREOF

(75) Inventors: HSIAO-CHUNG CHOU, Tu-Cheng (TW); CHUAN-HONG WANG, Tu-Cheng (TW); LI-ZHANG HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/475,505

(22) Filed: May 30, 2009

(30) Foreign Application Priority Data
Feb. 27, 2009 (CN) 200910300604.7

(51) Int. Cl. G06F 17/00

(52) U.S. Cl. 700/94

(57) ABSTRACT

An electronic apparatus with an interactive audio file recording function is provided. The apparatus starts a recording function of the apparatus to record the interactive audio file and generates an audio note file in response to a recording operation from an input unit, and records a main audio and the at least one question audio associated with the main audio and recorded related information of the main audio and the question audios to the file note file, and generates the interactive audio file according to the information noted in the audio note file.

### RELATED APPLICATIONS

This application is related to a commonly owned, co-pending U.S. patent application, with docket no. US18551, filed concurrently herewith and entitled “ELECTRONIC AUDIO PLAYING APPARATUS WITH AN INTERACTIVE FUNCTION AND METHOD THEREOF.”

### BACKGROUND

1. Technical Field

The present disclosure relates to an electronic apparatus with an interactive audio file recording function and method thereof.

2. Description of Related Art

Audio file formats recorded by electronic apparatus are generally, among others, AAC, AC-3, ATRAC3plus, MP3, and WMA9. Users can only play such files and cannot interact with them.

Therefore, what is needed is an electronic apparatus with an interactive audio file recording function and a method for such an apparatus to achieve the function.

### BRIEF DESCRIPTION OF THE DRAWINGS

The components of the drawings are not necessarily drawn to scale, the emphasis instead being placed upon clearly illustrating the principles of the electronic apparatus. Moreover, in the drawings, like reference numerals designate corresponding parts throughout several views.

FIG. 1 is a block diagram of an electronic apparatus with an interactive audio file recording function in accordance with an exemplary embodiment.

FIG. 2 is a schematic diagram of an exemplary audio note file stored in the electronic apparatus of FIG. 1.

FIG. 3 is a schematic diagram of an exemplary recording operation interface for recording an interactive audio file.

FIG. 4 is a schematic diagram of an exemplary main audio recording operation interface for recording a main audio of the interactive audio file.

FIG. 5 is a schematic diagram of an exemplary question audio recording operation interface for recording question audios of the interactive audio file.

FIG. 6 is a schematic diagram of an exemplary question editing interface for editing playing sequence of all the question audios.

FIG. 7 is a schematic diagram of a question editing interface according to an exemplary embodiment.

FIG. 8 is a schematic diagram of structure of the interactive audio file in accordance with an exemplary embodiment.

FIG. 9 is a schematic diagram of structure of the interactive audio file in accordance with another exemplary embodiment.

FIG. 10 is a flowchart of an interactive audio file recording method applied on the electronic apparatus of FIG. 1, in accordance with an exemplary embodiment.

### DETAILED DESCRIPTION

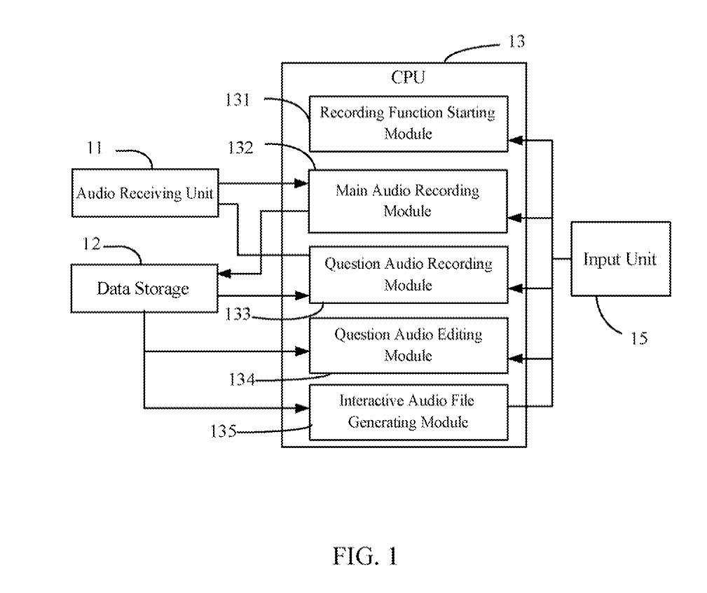

FIG. 1 is a block diagram of an electronic apparatus 100 with an interactive audio file recording function (hereafter “the apparatus 100”) in accordance with an exemplary embodiment. The apparatus 100 can be used to generate an interactive audio file. When an interactive audio file is played by the electronic apparatus 100, users can interact with the electronic apparatus 100.

The apparatus 100 includes an audio receiving unit 11, a data storage 12, a central processing unit (CPU) 13, and an input unit 15. The audio receiving unit 11, such as microphone, is for receiving audio signals generated around the audio receiving unit 11. The received audio signals are stored in the data storage 12.

The CPU 13 includes a recording function starting module 131, a main audio recording module 132, a question audio recording module 133, a question audio editing module 134, and an interactive audio file generating module 135.

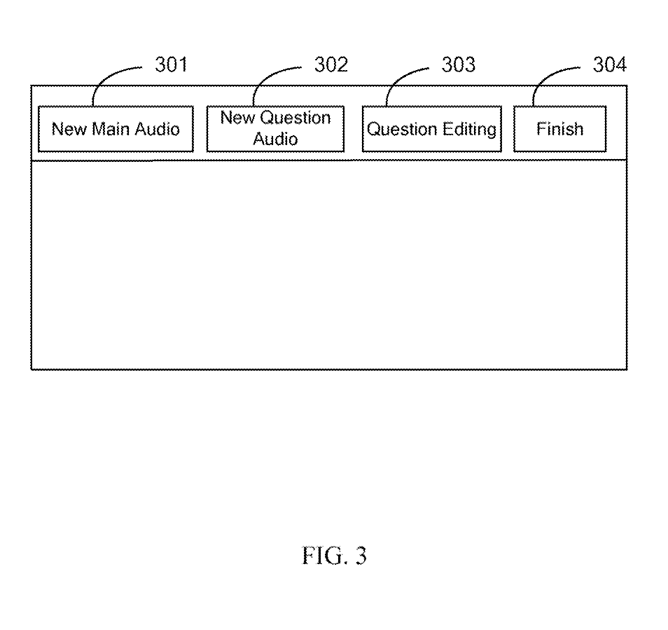

The recording function starting module 131 is for starting a recording function of the apparatus 100 to record the interactive audio file in response to a recording operation from the input unit 15. Typically, the recording function starting module 131 provides a recording operation interface (see FIG. 3) to record the interactive audio file and generate an audio note file. The recording operation interface, as shown in FIG. 3, includes a New Main Audio button 301, a New Question Audio button 302, a Question Editing button 303, and a Finish button 304. The interactive audio file is for storing a main audio and can store at least one question audio. The content of the main audio is, for example, a story, a song, an article or other audio content. Question audios stored by the interactive audio file regard the content of the main audio.

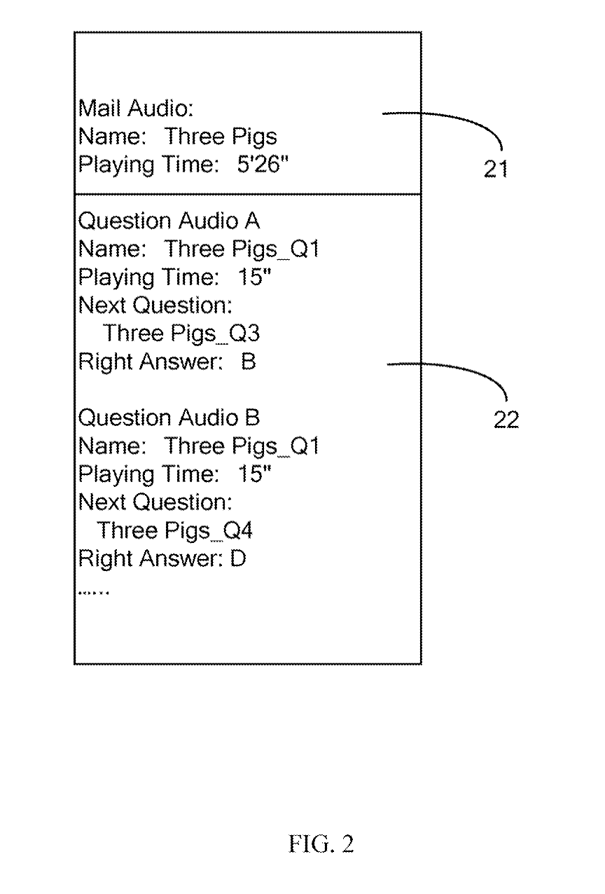

The audio note file is for storing related information of the interactive audio file. As shown in FIG. 2, an exemplary audio note file includes a main audio information part 21 and a question audio information audio part 22. The main audio information part 21 is for noting related information of the main audio. In this exemplary embodiment, the main audio information part 21 records, but not limited to, the name and the playing time of the main audio. The name of the main audio is “Three Pigs”. The playing time of the main audio is 5′26″. The question audio information part 22 is for noting related information of the question audios and includes at least one section. Each section associates with one audio question. Taken Question Audio A as an example, the related information of Question Audio A noted in the question audio information part 22 includes, but not limited to, the name such as Three Pigs_Q1, the playing time such as 15″, the next question such as Three Pigs_Q3, and the right answer of Question Audio A such as B.

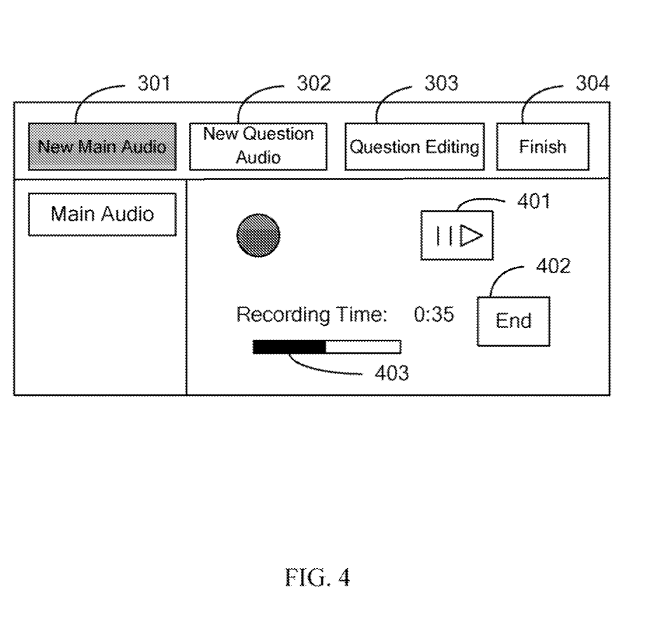

The main audio recording module 132 controls the audio receiving unit 11 to record the main audio and provides a main audio recording interface (see FIG. 4) to record the main audio, in response to a click operation on the New Main Audio button 301 from the user. The main audio recording interface, as shown in FIG. 4, includes a Pause/Start button 401, an End button 402, and a playing time bar 403 for indicating the playing time of the main audio. The Pause/Start button 401 is configured to generate a signal to pause or begin a recording process of the main audio. The End button 402 is configured to generate a signal to end the recording process of the main audio. When receiving the signal from the End button 402, the main audio recording module 131 stores the recorded main audio to the storage 11, and notes the related information of the main audio, such as the address, and the playing time to the main audio information part 21 of the audio note file. In the exemplary embodiment, the address of the main audio is associated with the name of the main audio.

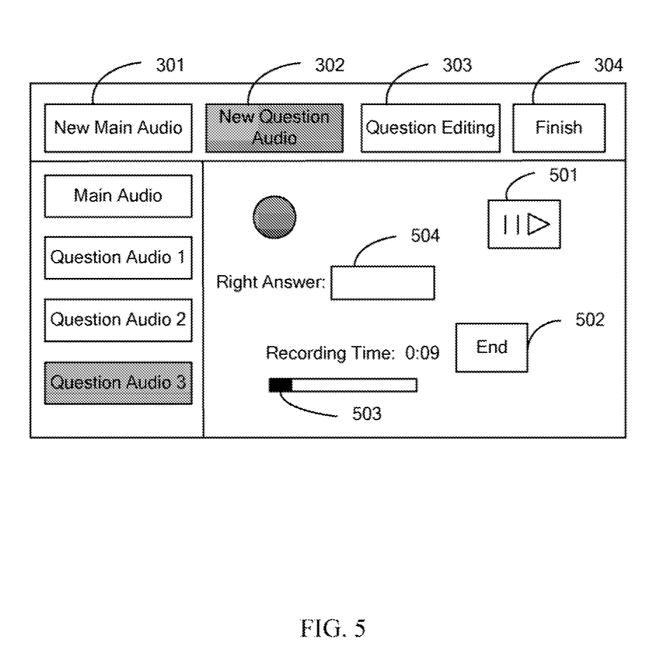

The question audio recording module 133 controls the audio receiving unit 11 to record the question audios associated with the recorded main audio and provides a question audio recording interface (see FIG. 5) for recording the question audio, in response to a click operation on the new question audio button 302 from the user. The question audio recording interface, as shown in FIG. 5, includes a pause/start button 501, an End button 502, a playing time bar 503 for indicating the playing time of each question audio, and a right answer edit box 504 for input a right answer of each question audio. The pause/start button 501 is configured to generate a signal to pause or start the recording process of each question audio. The End button 502 is configured to generate a signal to finish recording each question audio. When receiving the signal from the End button 502, the question audio recording module 133 stores the recorded question audio to the data storage 11, and notes related information of the question audio, such as address, playing time, and the right answer to the question audio information part 22 of the audio note file. In the exemplary embodiment, the address of each question audio associated with the name of each question audio.

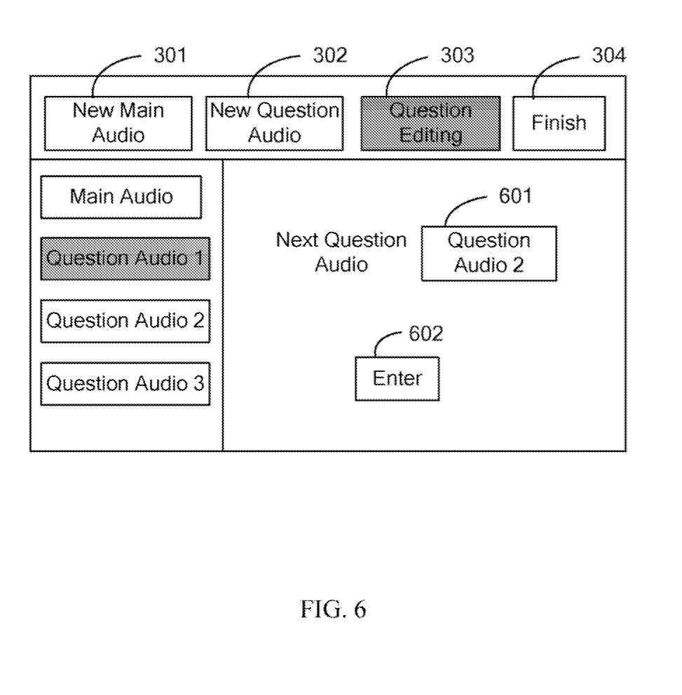

The question audio editing module 134 provides a question editing interface (see FIG. 6) to edit the playing sequence of all the question audios, in response to a click operation on the question editing button 303 from the user. The question editing interface, as shown in FIG. 6, includes a next question edit box 601 and an Enter button 602. The question editing interface lists the recorded question audios a on its left side for selection. The next question edit box 601 is provided for the user to input the name of the next question audio. If the question audio currently being edited is the last question audio, the user can input a predetermined word, such as “End”, in the next question edit box 601. When the next question audio of the question audio currently being edited is input into the next question edit box 601, and the enter button 602 is entered, the question audio editing module 134 notes the name of the next question audio of the question audio currently being edited to the question audio information part 22 of the audio note file.

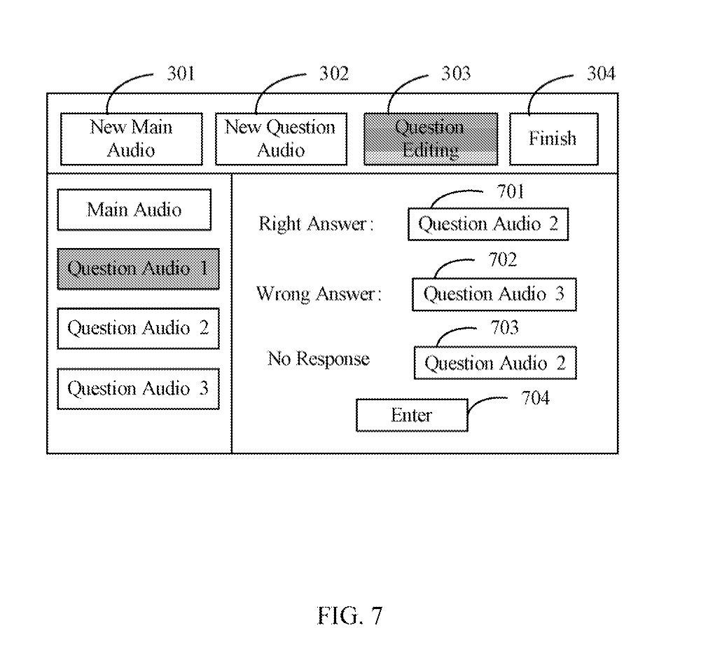

In another exemplary embodiment as shown in FIG. 7, the question editing interface includes a right answer edit box 701, a wrong answer edit box 702, a no response edit box 703, and an enter button 704. The right answer edit box 701 is for setting the next question audio when an answer from the user is right. The wrong answer edit box 702 is for setting the next question audio when the answer from the user is wrong. The no response edit box 703 is for setting the next question audio when there is no response from the user.

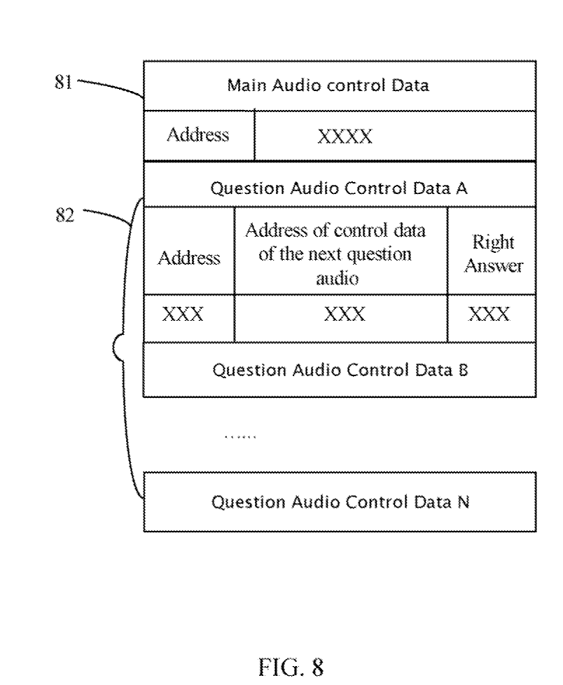

The interactive audio file generating module 135 ends the recording process of the interactive audio file in response to a click operation on the finish button 304, and generates the interactive audio file according to the information noted in the audio note file. The generated interactive audio file includes the main audio, the question audios, control data. The control data are a kind of metadata that describes the structure of the interactive audio file, as shown in FIG. 8. The control data includes a main audio control data 81 and at least one question audio control data 82. The main audio control data 81 notes an address that the main audio stores in the data storage 12 to control the playing of the main audio. Each of the question audio control data 82 is associated with a question audio, and notes information related to the associated question audio to control the playing of all the question audio. For example, the question audio control data 82 includes an address of the associated question audio and a right answer of the associated question audio. When the Finish button 304 is clicked, the interactive audio file generating module 135 obtains the address of the main audio from the audio note file and notes the address of the main audio to the main audio control data 81. The interactive audio file generating module 135 further obtains the address and the right answer of each question audio from the audio note file and notes the obtained address and right answer of each question audio to the associated question audio control data 82. The interactive audio file generating module 135 further obtains the address of the next question audio set for each question audio from the audio note file and notes the address of the question audio control data associated with the next question audio to the question audio control data 82 associated with each question audio.

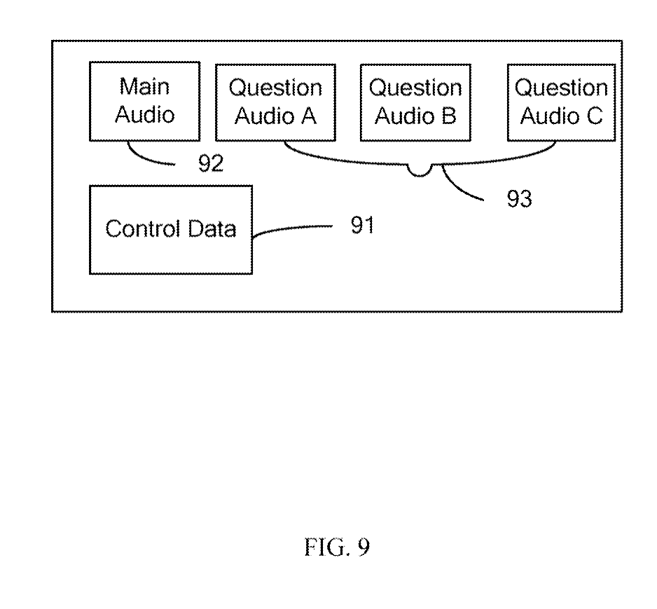

In another exemplary embodiment, the control data, the main audio, and a plurality of question audios are stored in the data storage as separate files, as shown in FIG. 9.

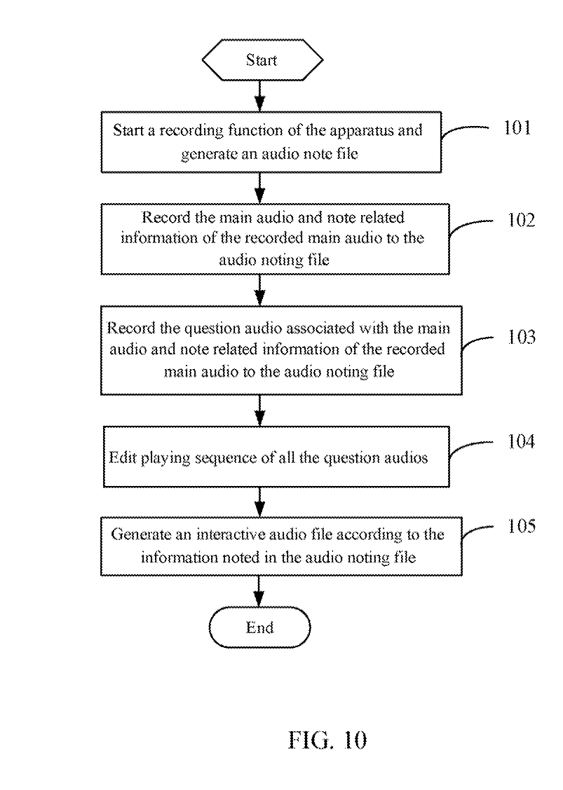

FIG. 10 is a flowchart of an interactive audio file recording method applied on the apparatus of FIG. 1. In step S101, the recording function starting module 131 starts a recording function of the apparatus 100 to record the interactive audio file and generate the audio note file in response to a recording operation from the input unit 16.

In step S102, the main audio recording module 132 records the main audio through the audio receiving unit 11 and notes related information of the recorded main audio to the audio note file.

In step S103, the question audio recording module 133 records the question audios associated with the main audio through the audio receiving unit 11, and notes related information of the recorded main audio to the audio note file.

In step S104, the question audio editing module 134 edits the playing sequence of all the question audios.

In step S105, the interactive audio file generating module 135 generates the interactive audio file according to the information noted in the audio note file in response to the click operation on the finish button 304 to end the recording process of the interactive audio file.

Although the present disclosure has been specifically described on the basis of preferred embodiments, the embodiments are not to be construed as being limited thereto. Various changes or modifications may be made to the embodiments without departing from the scope and spirit of the disclosure.

What is claimed is:

1. An electronic apparatus with an interactive audio file recording function, the apparatus comprising:
a recording function starting module for starting a recording function of the apparatus to record the interactive audio file and generating an audio note file in response to a recording operation from an input unit, wherein the interactive audio file comprises a main audio and at least one question audio associated with the main audio;
a main audio recording module for recording the main audio through an audio receiving unit and writing an address of the recorded main audio to the audio note file;
a question audio recording module for recording the at least one question audio associated with the main audio through the audio receiving unit, receiving a right answer of each question audio input from the user, and writing the address and the right answer of each question audio to the audio note file; and
an interactive audio file generating module for generating the interactive audio file according to the information noted in the audio note file, wherein the generated interactive audio file further comprises control data, the control data comprises a main audio control data and a plurality of question audio control data, each of the question audio control data is associated with one of the at least one question audio, the main audio control data comprises an address of the main audio and the question audio control data each comprises an address and the right answer of the associated question audio.

2. The apparatus as described in claim 1, further comprising a question audio editing module for setting the next question audio of the question audio currently being edited, and noting the set next question audio of the question audio currently being edited to the audio note file, wherein when generating the interactive audio file, the interactive audio file generating module obtaining the next question audio of each question audio from the audio note file and noting the address of the question audio control data of the next question audio to the question audio control data of each question audio.

3. The apparatus as described in claim 2, wherein the question audio editing module is further for setting the next question audio in a predetermined condition, wherein the predetermined condition is selected from the group consisting of a condition that an answer from the user is right, a condition that the answer from the user is wrong, and the condition that there is no response from the user.

4. The apparatus as described in claim 1, wherein the control data, the main audio, and a plurality of question audios are stored in a data storage as separate files.

5. An interactive audio file recording method applied on the electronic apparatus, the method comprising:
starting a recording function of the apparatus to record the interactive audio file and generating an audio note file in response to a recording operation from an input unit, wherein the interactive audio file comprises a main audio and at least one question audio associated with the main audio;
recording the main audio through an audio receiving unit and noting an address of the recorded main audio to the audio note file;
recording the at least one question audio associated with the main audio through the audio receiving unit;
receiving a right answer of each question audio input from the user;
noting an address and the right answer of each question audio to the audio note file; and
generating the interactive audio file according to the information noted in the audio note file, wherein the generated interactive audio file further comprises control data, the control data further comprises a main audio control data and a plurality of question audio control data, each of the question audio control data is associated with one of the at least one question audio, the main audio control data comprises an address of the main audio and the question audio control data comprises an address and the right answer of associated question audio.

6. The interactive method as described in claim 5, further comprising:
setting the next question audio of the question audio currently being edited;
noting the set next question audio of the question audio currently being edited to the audio note file;
wherein the step for generating the interactive audio file further comprises:
obtaining the next question audio of each question audio from the audio note file; and
writing an address of the question audio control data of the next question audio to the question audio control data of each question audio.

7. The method as described in claim 6, wherein in the step of setting the next question, the next question is set in a predetermined condition, wherein the predetermined condition is selected from the group consisting of a condition that an answer from the user is right, a condition that the answer from the user is wrong, and the condition that there is no response from the user.

8. The method as described in claim 1, wherein the control data, the main audio, and a plurality of question audios are stored in the data storage as separate files.
